(19) United States
(12) Patent Application Publication
(10) Pub. No.: US 2022/0224097 A1
(43) Pub. Date: Jul. 14, 2022

(54) CABLE-ENTRY DEVICE FOR AN ELECTRONIC CHASSIS

(71) Applicant: Quanta Computer Inc., Taoyuan (TW)

(72) Inventors: Yaw-Tzorng TSORNG, Taoyuan City (TW); Ming-Lung WANG, Taoyuan City (TW); Yuan-Chi CHANG, Taoyuan City (TW)

(21) Appl. No.: 17/231,760

(22) Filed: Apr. 15, 2021

Related U.S. Application Data
(60) Provisional application No. 63/137,478, filed on Jan. 14, 2021.

(51) Int. Cl. H02G 3/22

(52) U.S. Cl. CPC H02G 3/22

(57) ABSTRACT

A cable entry device for guiding cables through an aperture of an electronic equipment chassis is disclosed. The cable entry device includes a flexible base member. The flexible base has a grommet with a bore therethrough. A slit is formed through the grommet. The grommet holds a cable in the bore. The cable entry device includes a frame mated to the base member. The frame includes an aperture that is operable to receive the cable. The aperture is aligned with the bore of the grommet. The frame holds the base member to the electronic equipment chassis so the grommet extends through the aperture of the electronic equipment chassis.

### CROSS-REFERENCE TO RELATED APPLICATIONS

This application claims benefit to and priority under 35 U. S.C. § 119 to U.S. Provisional Application No. 63/137,478, entitled “CABLE ENTRY SYSTEM DESIGN AND APPLICATION ON ELECTRONIC DEVICE,” and filed on Jan. 14, 2021. The contents of that application are hereby incorporated by reference in their entirety.

### TECHNICAL FIELD

The present invention relates generally to a cable entry device for cables connecting to an electronic chassis and, more specifically, to a cable entry device having a frame and a base with grommets for flexible and waterproof installation of cables.

### BACKGROUND

Cellular networks rely on various electronic devices, such as radios and antennas, which are mounted on support structures exposed to the environment. Some of those support structures are very tall, oftentimes at heights of 100 feet or more. As such, these electronic devices are exposed to inclement weather. Advancements in technology have led to 5G networks that require several interconnected devices having chasses that receive cables. Because of the need to permit cables to enter the chassis of an individual device, various methods have been utilized to help restrict water and debris from entering the chassis from the region around the cables.

One example of an existing cable entry device is illustrated in FIG. 1. A 5G electronic chassis 10 includes a top cover 12 and a base 14. For example, the electronic chassis 10 is a cabinet that houses electronic equipment that is attached via cables to other components such as 5G Central Units (CU), distributed units (DU), Remote Radio Units (RRU), Active Antenna Units (AAU), and Radio Units (RU).

At the interface between the top cover 12 and the base 14, there are rubber pieces 18a, 18b having openings 16 that provide access for cables and wiring (hereinafter “cables”). For any opening 16 that is not used for a cable, a plug 20 is inserted to seal it. With the top cover 12 removed from the base 14, the cables are inserted into the openings 16. The top cover 12 is then placed over the base 14 and the screws 22 are tightened to mate the top cover 12 and the base 14 together, which also forces the rubber pieces 18a, 18b against the cables. However, in these existing systems, the types and sizes of the cables to be used within the electronic device may change over its life cycle. Further, it is difficult to have the cables match the openings 16 formed by the rubber pieces 18a, 18b. Finally, it is often difficult to control the small gaps around the rubber pieces 18a, 18b as pressure is applied by the screws 22.

FIG. 2 represents another existing device for permitting entry of cables into the electronic chassis 10. An electronic cable gland 30 is located on a wall of the electronic chassis 10, such as a wall on the top cover 12. On the exterior side of the electronic chassis 10, a cable 32 terminates at the electronic cable gland 30 and forms an electrical connection with the electronic cable gland 30. On the interior side of the electronic chassis 10, the electronic cable gland 30 includes pins that are interconnected with a connector 33 on a printed circuit board 34. The problem with the electronic cable gland 30 is that the printed circuit board 34 must be directly adjacent to the electronic cable gland 30, which restricts the location of the electrical components in the electronic chassis 10.

As such, a need exists for a cable entry device that allowing flexibility of the location of electrically connected components in an electronic equipment chassis to cables, while protecting the interior of the electronic equipment chassis from water and debris. There is further a need for a cable entry device that provides flexibility in the sizes of cables that enter the electronic equipment chassis. There is also a need for a cable entry device that is easy to assemble and install in an electronic equipment chassis.

### SUMMARY

The term embodiment and like terms are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter; nor is it intended to be used in isolation to determine the scope of the claimed subject matter. The subject matter should be understood by reference to appropriate portions of the entire specification of this disclosure, any or all drawings and each claim.

According to one aspect of the present disclosure, a cable entry device for guiding cables through an aperture of an electronic equipment chassis is disclosed. The cable entry device has a flexible base member including a grommet with a bore therethrough. The flexible base member includes a slit through the grommet. The grommet is configured to hold a cable in the bore. A frame is mated to the base member. The frame includes an aperture that is configured to receive the cable. The aperture is aligned with the bore of the grommet. The frame holds the base member to the electronic equipment chassis so the grommet extends through the aperture of the electronic chassis.

According to a configuration of the above implementation, the frame includes an upper frame member and a lower frame member that are mated together. According to another configuration of the above implementation, the upper and lower frame members are identical. According to another configuration of the above implementation, the upper and lower frame members each include a central tab extending on one end and a pair of arms extending on an opposite end. The central tab of the upper frame member may be inserted between the pair of arms of the lower frame member when the upper and lower frame members are mated together. According to another configuration of the above implementation, the upper and lower frame members each include a registration feature to align the central tab between the pair of arms of the other frame member. According to another configuration of the above implementation, the base member is rubber and the frame is plastic or metal. According to another configuration of the above implementation, the grommet and slit are one of a plurality of grommets and slits of the base member. According to another configuration of the above implementation, the bores in the individual grommets have different internal diameters for receiving cables of different sizes. According to another configuration of the above implementation, the bores in the individual grommets have the same internal diameter for receiving cables. According to another configuration of the above implementation, the frame and the base member include a connector hole to receive a fastener to connect the frame and the base to the chassis.

Another aspect of the present disclosure includes an electronics device intended for placement in an outside environment. The electronic device includes a chassis having an aperture to receive at least one cable. The electronic device includes a cable entry device inserted over the aperture. The cable entry device includes a flexible base member having a grommet with a bore therethrough. A slit is formed through the grommet. The bore is operable to hold the cable. The cable entry device includes a frame mated to the base member. The frame includes an aperture that is operable to receive the cable. The aperture is aligned with the bore of the grommet. The frame holds the base member to the chassis so the grommet extends through the aperture of the chassis.

According to another configuration of the above implementation, the frame includes an upper frame member and a lower frame member that are mated together. According to another configuration of the above implementation, the upper and lower frame members each include a central tab extending on one end and a pair of arms extending on an opposite end. The central tab of the upper frame member may be inserted between the pair of arms of the lower frame member when the upper and lower frame members are mated together. According to another configuration of the above implementation, the upper and lower frame members each include a registration feature to align the central tab between the pair of arms of the other frame member. According to another configuration of the above implementation, the base member is rubber and the frame member is plastic or metal. According to another configuration of the above implementation, the grommet and slit are one of a plurality of grommets and slits of the base member. According to another configuration of the above implementation, the bores in the individual grommets have different internal diameters for receiving cables of different sizes. According to another configuration of the above implementation, the bores in the individual grommets have the same internal diameter for receiving cables. According to another configuration of the above implementation, the frame and the base member include a connector hole therein operable to receive a fastener to connect the frame and the base member to the chassis.

A further aspect of the present disclosure includes a cable entry device for guiding cables through an aperture of an electronic equipment chassis. The cable entry device has a flexible base member including a first side tab and a second side tab. The flexible base member has grommets each with a bore therethrough, and a slit through each of the grommets. Each of the grommets are configured to hold a cable in the bore. An upper frame member is mated to the first side tab of the base member. The upper frame member includes apertures, each of which are in alignment with the bore of one of the grommets. A lower frame member is mated to the second side tab of the base member. The lower frame member includes a registration feature to seat the lower frame with the upper frame member. The grommets extend through the chassis when the base member is mated to the upper and lower frame members.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims. Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

The disclosure, and its advantages and drawings, will be better understood from the following description of exemplary embodiments together with reference to the accompanying drawings. These drawings depict only exemplary embodiments, and are therefore not to be considered as limitations on the scope of the various embodiments or claims.

FIG. 1 is a perspective view of a prior art device for permitting cables to enter an electronic chassis;

FIG. 2 is a perspective view of another prior art device for permitting cables to enter an electronic chassis;

FIG. 3A is a perspective assembled view of an example cable entry device, according to certain aspects of the present disclosure;

FIG. 3B is a perspective exploded view of a frame and a base member of the example cable entry device in FIG. 3A, according to certain aspects of the present disclosure;

FIG. 3C is a side view of the grommet side of the example cable entry device in FIG. 3A, according to certain aspects of the present disclosure;

FIG. 3D is a top view of the example cable entry device in FIG. 3A, according to certain aspects of the present disclosure;

FIG. 4A is a perspective view of the grommet side of a flexible base member of the example cable entry device in FIG. 3A, according to certain aspects of the present disclosure;

FIG. 4B is a perspective view of the opposite side of the flexible base member of the example cable entry device in FIG. 3A, according to certain aspects of the present disclosure;

FIG. 4C is a side view of the grommet side of the flexible base member of the example cable entry device in FIG. 3A, according to certain aspects of the present disclosure;

FIG. 4D is a side view of the opposite side of the flexible base member of the example cable entry device in FIG. 3A, according to certain aspects of the present disclosure;

FIG. 4E is a top view of the flexible base member of the example cable entry device in FIG. 3A, according to certain aspects of the present disclosure;

FIG. 5A is a perspective view of the frame components of the cable entry device of FIG. 3A, according to certain aspects of the present disclosure;

FIG. 5B is a perspective view of the frame components assembled with the flexible base to form the example cable entry device in FIG. 3A, according to certain aspects of the present disclosure;

FIG. 5C is a side view of the assembled example cable entry device in FIG. 3A, according to certain aspects of the present disclosure;

FIG. 6A is a side view of a cable entry aperture of an electronic equipment chassis that holds the example cable entry device for insertion of cables, according to certain aspects of the present disclosure.

FIG. 6B shows a side view of the base member of the cable entry device in FIG. 3A aligned with a cable entry aperture of the electronic equipment chassis in FIG. 6A, according to certain aspects of the present disclosure;

FIG. 6C shows a top view of the cables that are held by the base member of the cable entry device when attached to the electronic equipment chassis in FIG. 6A, according to certain aspects of the present disclosure;

FIG. 6D is a perspective view of the cables inserted in the base member of the cable entry device, according to certain aspects of the present disclosure;

FIG. 6E illustrates a perspective view of cables entering the electronics equipment chassis after the frame components have been joined to the base member, according to certain aspects of the present disclosure; and

FIG. 6F shows a side view of the cable entry device attached to the electronic equipment chassis to allow the sealed entry of the cables, according to certain aspects of the present disclosure.

While the invention is susceptible to various modifications and alternative forms, specific implementations have been shown by way of example in the drawings and will be described in further detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

Various embodiments are described with reference to the attached figures, where like reference numerals are used throughout the figures to designate similar or equivalent elements. The figures are not drawn to scale and are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details, or with other methods. In other instances, well-known structures or operations are not shown in detail to avoid obscuring the invention. The various embodiments are not limited by the illustrated ordering of acts or events, as some acts may occur in different orders and/or concurrently with other acts or events. Furthermore, not all illustrated acts or events are required to implement a methodology in accordance with the present invention.

Elements and limitations that are disclosed, for example, in the Abstract, Summary, and Detailed Description sections, but not explicitly set forth in the claims, should not be incorporated into the claims, singly, or collectively, by implication, inference, or otherwise. For purposes of the present detailed description, unless specifically disclaimed, the singular includes the plural and vice versa. The word “including” means “including without limitation.” Moreover, words of approximation, such as “about,” “almost,” “substantially,” “approximately,” and the like, can be used herein to mean “at,” “near,” or “nearly at,” or “within 3-5% of,” or “within acceptable manufacturing tolerances,” or any logical combination thereof, for example. Similarly, terms “vertical” or “horizontal” are intended to additionally include “within 3-5% of” a vertical or horizontal orientation, respectively. Additionally, words of direction, such as “top,” “bottom,” “left,” “right,” “above,” and “below” are intended to relate to the equivalent direction as depicted in a reference illustration; as understood contextually from the object(s) or element(s) being referenced, such as from a commonly used position for the object(s) or element(s); or as otherwise described herein.

The present disclosure is directed toward a cable entry device for holding and guiding cables that are inserted into a chassis of electronics equipment for outside use. The cable entry device has a base member that has one or more grommets to hold the cables. The base member is mated to a frame that allows installation of the cable entry device around an aperture in the chassis. The cable entry device controls the gap between the cables and the cable entry device, while allowing flexibility of the location of components in the chassis that are connected to the cables. For example, the chassis may be a 5G equipment cabinet that has cables leading to other 5G components such as 5G Central Units (CU), distributed units (DU), Remote Radio Units (RRU), Active Antenna Units (AAU), and Radio Units (RU). The cable entry device may be mated with any housing for an electronic device where a seal is desired to prevent inflow of water or debris. The cable entry device may be installed by drilling holes in proximity to an aperture for cables on an exterior panel of the chassis. The example cable entry device allows a cable infeed to the chassis without interruption and is easy to assemble. The cable entry device is compliant with Ingress Protection (IP) standards such as IP6X, IPX5 and IPX7. Thus, the example cable entry device provides high protection to an electronic equipment chassis from infiltration of external particles from the point of entry of the cables.

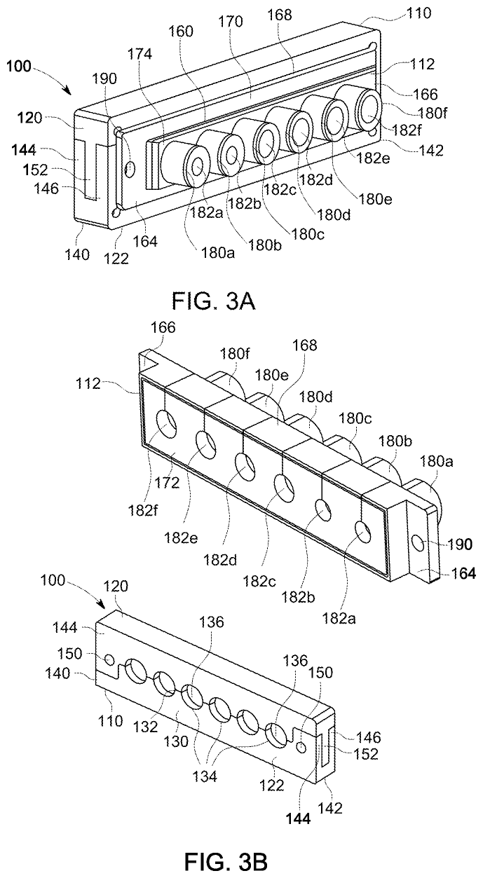

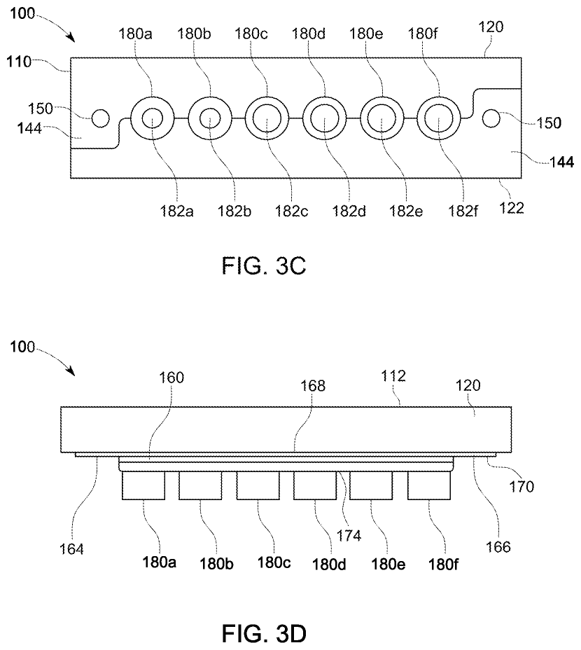

FIGS. 3A-3D illustrate an example cable entry device 100. FIG. 3A is a perspective view of the example cable entry device 100 in assembled form. FIG. 3B is a perspective exploded view of the parts of the example cable entry device 100. FIG. 3C is a front view of the example cable entry device 100, and FIG. 3D is a top view of the example cable entry device 100. The cable entry device 100 allows external cables to be held for connection to an electronic equipment chassis. The electronic equipment chassis may be for example, an outdoor equipment cabinet that holds electronic components for a 5G communication system. It is to be understood that the present cable entry device may be used with any appropriate electronic communication chassis that accepts external cables and requires protection from outside environmental conditions and debris at the cable entry point. The cable entry device 100 may be used with cables of varying diameters.

As shown in FIG. 3A, the cable entry device 100 includes a frame 110 and a base member 112. As will be explained below, the base member 112 has multiple grommets that hold the cables. The frame 110 is roughly rectangular in shape and includes an upper frame member 120 and a lower frame member 122 that are interlocked/mated to form the frame 110. The upper frame member 120 and the lower frame members 122 fit together to hold the base member 112 between them. As will be explained below, the frame 110 allows the base member 112 to be inserted in an aperture in a panel of an electronic equipment chassis to hold cables.

In the example shown in FIGS. 3A-3D, the upper frame member 120 and the lower frame member 122 are fabricated from resilient and weather-proof material such as treated metal or plastic. The upper and lower frame members 120 and 122 are identical components in this example. Thus, both upper and lower frame members 120 and 122 have a forward plate 130 that includes a mating edge 132 with a series of semi-circular cutouts 134. In this example, the cable entry device 100 may accommodate six cables, and thus there are six semi-circular cutouts 134 on each of the upper frame member 120 and the lower frame member 122. When mated together, the two respective cutouts 134 from the frame members 120 and 122 form a circular aperture 136 for insertion of a cable. The aperture 136 allows access to the base member 112 when the frame members 120 and 122 are assembled together. Of course, any number of cutouts may be formed in the frame members 120 and 122 and thus any number of cables may be supported by the cable entry device 100.

The upper and lower frame members 120 and 122 have opposing ends 140 and 142. One of the ends 142 includes an exterior arm 144 and an interior arm 146. The exterior arm 144 and the interior arm 146 are located parallel to each other with a gap between the arms 144 and 146. Each of the exterior arm 144 and the interior arm 146 includes a fastener installation hole 150 extending therethrough. The opposite end 140 of the upper frame member 120 includes a central tab 152 that includes a fastener installation hole. When the upper and lower frame members 120 and 122 are mated together, the central tab 152 on the end 140 of the upper frame member 120 is inserted in the gap between the exterior arm 144 and the interior arm 146 of the lower frame member 122, such that the installation holes 150 of the exterior arm 144 and the interior arm 146 of the lower frame member 122 are in alignment with the installation hole of the central tab 152. The central tab 152 of the lower frame member 122 on the opposite side is inserted between the arms 144 and 146 of the upper frame member 120 so the installation holes 150 of the arms 144 and 146 are in alignment with the installation hole of the central tab 152.

The flexible base member 112 includes a grommet side that is inserted to face an electronic equipment chassis, and an opposite side that is in contact with the frame 110. The grommet side of the flexible base member 112 includes a rectangular central block 160 that is held between the upper and lower frame members 120 and 122 when assembled. The rectangular central block 160 has two side tabs 164 and 166 on opposite ends. The tabs 164 and 166 fit in an interior recess of the respective interior arms 146 of the respective upper and lower frame members 120 and 122. The rectangular central block 160 is defined by a top surface 168 that is flush with the tops of the tabs 164 and 166. The central block 160 includes a grommet surface 170 that includes one side of the tabs 164 and 166 on the grommet side and an opposite interior surface 172. A rectangular raised projection 174 is formed on the grommet surface 170. Six cylindrical cable grommets 180a-180f extend from the surface of the projection 174 of the central block 160. Each of the grommets 180a-180f have respective bores 182a-182f extending through the respective grommets and the central block 160 to allow for insertion of a cable. Each of the side tabs 164 and 166 include a fastener connection hole 190 that is aligned with fastener installation holes 150 of the respective arms 144 and 146 of the upper and lower frame members 120 and 122 and the fastener installation hole of the central tabs 152.

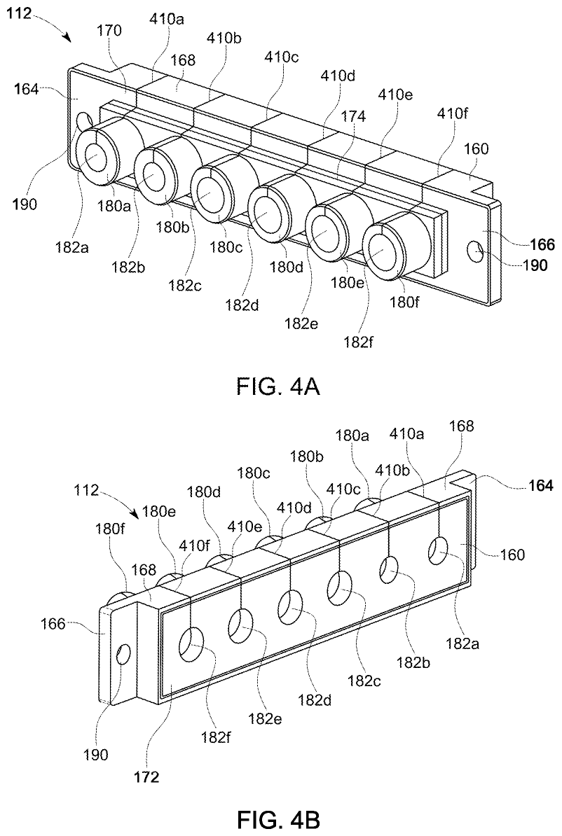

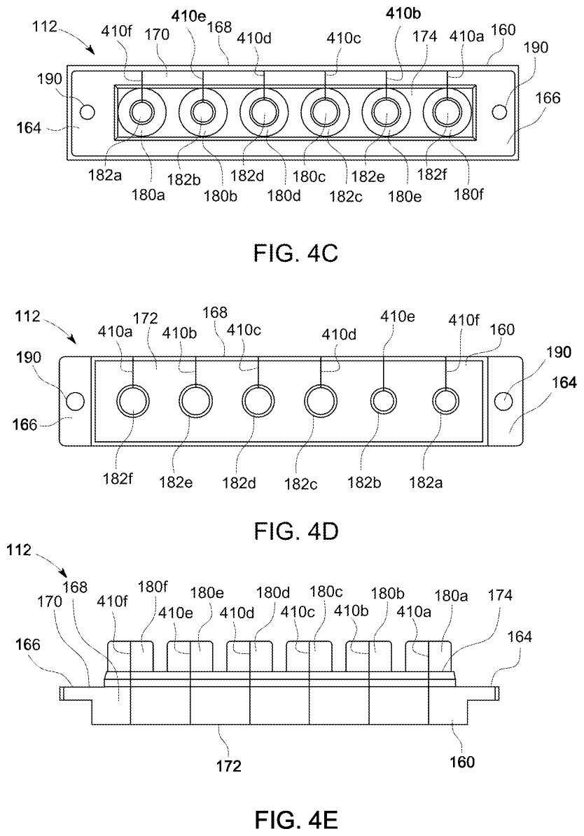

FIG. 4A is a perspective view of the grommet side of the flexible base member 112 of the example cable entry device 100 in FIG. 3A. FIG. 4B is a perspective view of the opposite side of the flexible base member 112 from the grommet side. FIG. 4C is a side view of the grommet side of the flexible base member 112. FIG. 4D is a side view of the opposite side of the flexible base member 112. FIG. 4E is a top view of the flexible base member 112. Like elements in FIGS. 4A-4E are labeled with like reference numbers in FIGS. 3A-3D. In this example, the base member 112 is a one-piece component that is fabricated from a resilient and flexible material such as rubber.

In the example shown in FIGS. 4A-4D, the diameter of the bores 182a-182f may be selected based on the outer diameter of the cables for use with the cable entry device 100. Thus, the example cable entry device 100 may be adapted to cables of different sizes by setting the appropriate grommet bore diameter to snuggly fit with the desired outer diameter of cables for a waterproof interface. Thus, different cable entry devices 100 may be used for cables with outer diameters between 3-12 mm. As an example, RJ45 cables may have an outer diameter of 5.5 mm; optical fiber cables may have an outer diameter of 9.5 mm; DC power cables may have an outer diameter of 8 mm; and USB cables may have an outer diameter of 5.0 mm. Alternatively, the grommets may be selected to have bores of different diameters when cables of different diameters are used. In this example, four bores 182a-182b of the grommets 180a-180b have a relatively smaller diameter of 8 mm for cables having an outer diameter between about 8-9 mm. The bores 182c-182f of the grommets 180c-180f have a relatively larger diameter of 9 mm for cables having an outer diameter between about 9-10 mm.

A series of slits 410a-410f are cut from the top surface 168 of the central block 160 through each of the grommets 180a-180f. The slits 410a-410f allow for the insertion of a cable in the respective grommet 180a-180f from the top surface 168. The material of the central block 160 is deformable and thus the sides of the slits 410a-410f may be pulled apart for insertion of the cable in the respective grommet 180a-180f. The sides of the slits 410a-410f may then be released to a position abutting each other to hold the cable in the corresponding grommet 180a-180f.

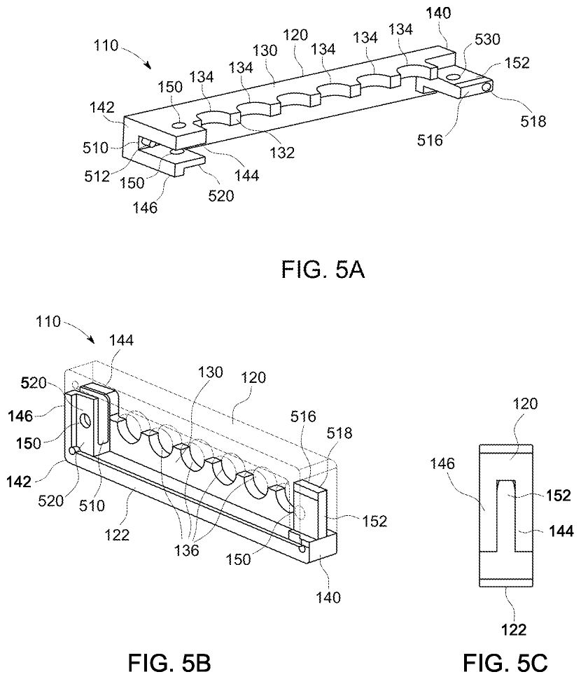

FIG. 5A is a perspective view of the frame members 120 of the cable entry device 100 of FIG. 3A. FIG. 5B is a perspective view of the frame members 120 and 122 assembled with each other. FIG. 5C is a side view of the assembled frame members 120 and 122. Like elements in FIGS. 5A-5B are labeled with like reference numerals from FIGS. 3A-3B. A bottom surface 510 separates the exterior arm 144 and the interior arm 146. The upper and lower frame members 120 and 122 include a registration feature to align the central tab 152 between the pair of arms 144 and 146 of the opposite frame member 120 or 122. In this example, the registration feature is a guide pin and a matching guide hole. Thus, a guide pin 512 extends from the bottom surface 510 between the exterior arm 144 and the interior arm 146. A top edge 516 of the central tab 152 includes a guide hole 518 that is mated with the guide pin 512 of the opposite frame member when the upper and lower frame members 120 and 122 are mated together. The interior arm 146 includes an interior recess 520 that is configured to accommodate/be flush with the tabs 164 and 166 of the base 112. The central tab 152 includes an installation hole 530 that is aligned with the installation holes 150 of the arms 144 and 146 when the upper frame member 120 is mated with the lower frame member 122, and vice versa.

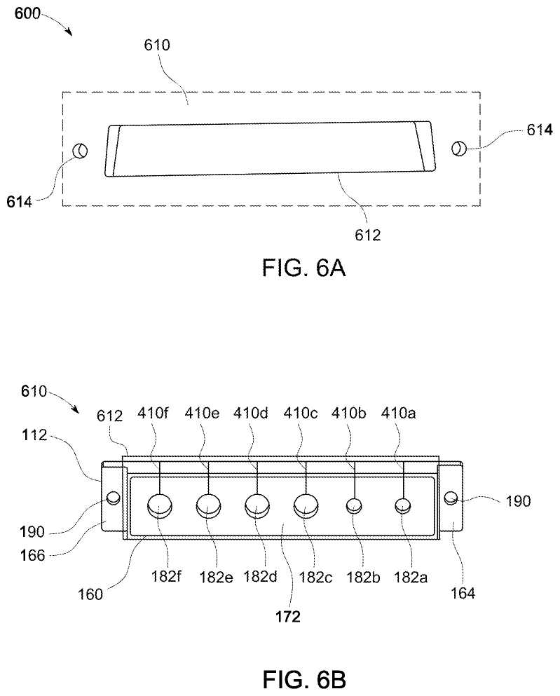

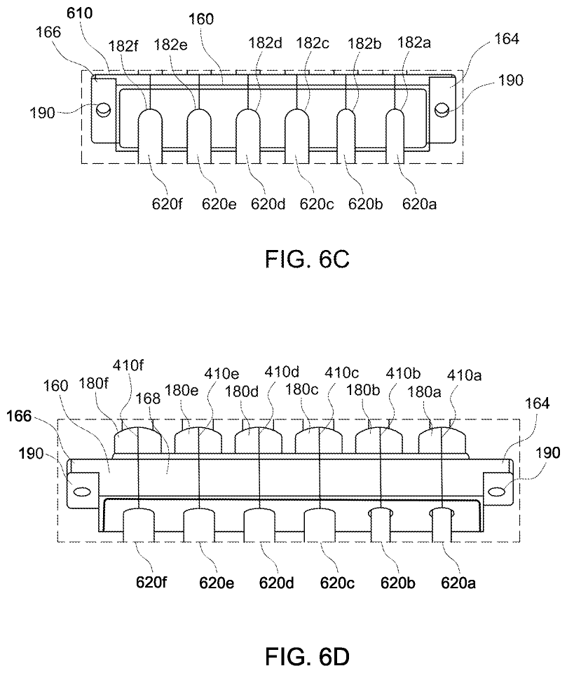

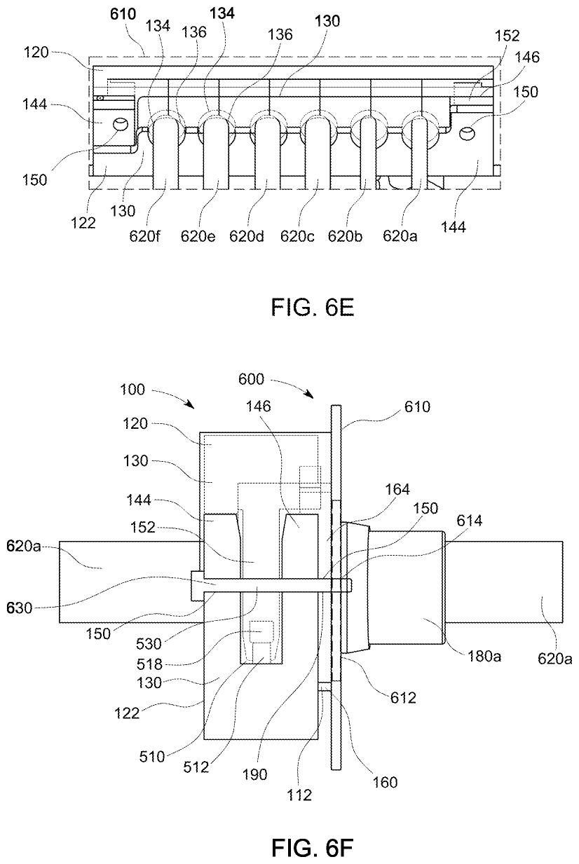

The process of attaching cables to an electronic equipment chassis is facilitated by the example cable entry device 100. This process of attaching cables using the cable entry device 100 is shown in FIGS. 6A-6D. Like elements in FIGS. 6A-6D are labeled with identical reference numbers as their counterparts in FIGS. 3A-5C.

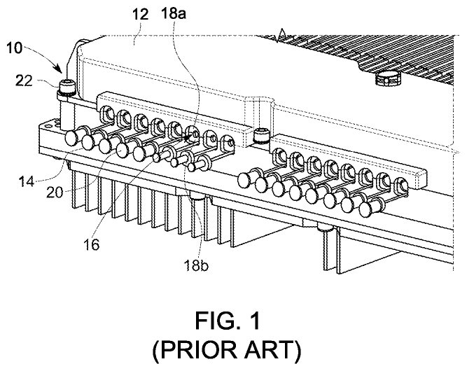

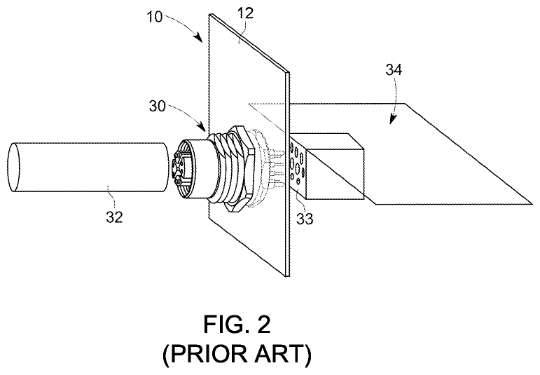

FIG. 6A is a front view of an electronic equipment chassis 600 that may have cables inserted via the example cable entry device 100. The chassis 600 includes a panel 610 that may be a part of a cover of the electronic equipment chassis 600 (e.g., a 5G electronics chassis). The electronic equipment chassis 600 may be in various forms, such as the general form of the electronic chassis 10 shown in FIG. 1. The panel 610 includes a roughly rectangular shaped aperture 612 that is cut through the panel 610 that allows for the attachment of the cable entry device 100 in FIGS. 3A-3D. The cables thus enter the electronic equipment chassis 600 through the aperture 612. The ends of the cables may be attached to internal components contained in the electronic equipment chassis 600. Two installation holes 614 are drilled through the panel 610 on either side of the aperture 612 to allow the attachment of the cable entry device 100.

FIG. 6B shows the alignment of the base 112 of the cable entry device 100 to the aperture 612 in FIG. 6A. The base 112 is placed in alignment so the fastener insertion holes 190 of the tabs 164 and 166 are aligned to the installation holes 614 shown in FIG. 6A. The surface 172 faces outward allowing access to the bore holes 182a-182f. The slits 410a-410f are separated to allow the block 160 to be deformed and separated to allow the insertion of cables. Thus, the grommets 180a-180f shown in FIGS. 4A-4B are inserted into the aperture 612 in FIG. 6A.

FIGS. 6C and 6D show the base member 112 and the electronic equipment chassis 600 after cables 620a-620f have been inserted in the bores 182a-182f via the slits 410a-410f that extend through the top surface 168 and the grommets 180a-180f In this example, the cables 620a-620b have relatively smaller outer diameter of about 8.5 mm, while the cables 620c-620f have relatively larger outer diameter of about 9.5 mm. Other cables having different diameters may be used with appropriate modifications to the bores and grommets. The base member 112 may also be fabricated to accommodate cables all have the same diameter.

FIG. 6E shows the assembly of the frame members 120 and 122 to the base member 112 of the cable entry device 100 after the cables 620a-620f are installed. After the cables 620a-620f are inserted in the base member 112, the upper and lower frame members 120 and 122 are mated to the base member 112. Thus, the interior arm 146 of the upper frame member 120 overlaps the side tab 166 while the interior arm 146 of the lower frame member 122 overlaps the side tab 164. The central tab 152 of the upper frame member 120 is inserted between the exterior arm 144 and the interior arm 146 of the lower frame member 122. The central tab 152 of the lower frame member 122 is inserted between the exterior arms 144 and the interior arm 146 of the upper frame member 120. The respective guide pins 512 between the exterior arm 144 and the interior arm 146 are inserted in the guide holes 518 of the central tabs 152. This interlocking structure occurs at both ends of the upper and lower frame members 120 and 122. The forward plates 130 of the upper and lower frame members 120 and 122 are moved in contact with each other so the cutouts 134 align with each other to form the apertures 136. The cables 620a-620f thus extend through the apertures 136 formed by the joining of the forward plates 130.

FIG. 6F shows a side view of the cable entry device 100 installed on the chassis 600. As show in FIG. 6F, when assembled, the joined forward plates 130 of the upper and lower frame members 120 and 122 abut the base member 112. The central block 160 of the base member 112 thus is sandwiched between the forward plates 130 of the frame members 120 and 122 and the panel 610 of the chassis 600. The guide pin 512 extending from area 510 between the two arms 144 and 146 of the lower frame member 122 is inserted in the guide hole 518 of the central tab 152 of the upper frame member 120.

A fastener such as a screw 630 is then inserted in the fastener holes 150 in the exterior arm 144 and the interior arm 146, the fastener hole 530 in the central tab 152, the fastener installation hole 190 of the side tab 164, and the hole 614 of the panel 610. A similar fastener is inserted through the corresponding holes on the other side of the frame 110 through the side tab 166. Thus, the fasteners such as the screw 630 holds the base member 112, the upper and lower frame members 120 and 122 to the panel 610. The grommets, such as the grommet 180a, extend through the aperture 612 into the interior of the electronic equipment chassis 600. Thus, the cables such as the cable 620a are introduced into the interior of the electronic equipment chassis 600 where they can be connected to components in the electronic equipment chassis 600.

Thus, where the electronic equipment chassis 600 is a 5G communication component, the cables 620a-620f may be connected to other 5G components such as a Central Unit (CU), a Distributed Unit (DU), a Remote Radio Unit (RRU), an Active Antenna Unit (AAU), a Radio Unit (RU), or the like. However, any electronic equipment chassis that requires cables may use the cable entry device 100 incorporating the principles described herein.

As shown in FIGS. 6C-6F, the cable entry device 100 permits cables 620a-620f to enter and exit the electronic equipment chassis 600 via the aperture 612 through the grommets 180a-180f. The upper and lower frame members 120 and 122, and the base member 112 are easy to assemble. The grommets 180a-180f on the base member 112 and the resilient material of the base member 112 inhibit entry of water and/or contaminates into the chassis 600. As noted above, the diameter of each bore in each of the grommets 180a-180f can be specifically sized to receive a certain size of cable. Further, some grommets in the base member 112 can be “dummies” in that they contain no internal bore, but are instead solid. Alternatively, a plug element may be fashioned to plug any unused grommets of the base member 112 to prevent entry of water and/or contaminates.

A kit of cable entry devices such as the cable entry device 100 (perhaps provided with color-coding or other indicia to indicate the cables to which they apply) may have different sizes to accommodate various cables.

The example cable entry device 100 eliminates a complex mating design with the provision of holes for fasteners. The example cable entry device 100 is compliant with Ingress Protection (IP) standards such as IP6X, IPX5 and IPX7. The example cable entry device 100 allows a cable infeed to an equipment cabinet in outdoor environments without interruption and is easy to assemble.

The foregoing description of the embodiments, including illustrated embodiments, has been presented only for the purpose of illustration and description and is not intended to be exhaustive or limiting to the precise forms disclosed. Numerous modifications, adaptations, and uses thereof will be apparent to those skilled in the art.

Although the disclosed embodiments have been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

While various embodiments of the present invention have been described above, it should be understood that they have been presented by way of example only, and not limitation. Numerous changes to the disclosed embodiments can be made in accordance with the disclosure herein, without departing from the spirit or scope of the invention. Thus, the breadth and scope of the present invention should not be limited by any of the above described embodiments. Rather, the scope of the invention should be defined in accordance with the following claims and their equivalents.

The terminology used herein is for the purpose of describing particular embodiments only, and is not intended to be limiting of the invention. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof, are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art. Furthermore, terms, such as those defined in commonly used dictionaries, should be interpreted as having a meaning that is consistent with their meaning in the context of the relevant art, and will not be interpreted in an idealized or overly formal sense unless expressly so defined herein.

What is claimed is:

1. A cable entry device for guiding cables through an aperture of an electronic equipment chassis, the cable entry device comprising:
a flexible base member including a grommet with a bore therethrough, and a slit through the grommet, the grommet configured to hold a cable in the bore; and
a frame mated to the base member, the frame including an aperture aligned with the bore of the grommet and configured to receive the cable, wherein the frame holds the base member to the electronic equipment chassis so the grommet extends through the aperture of the electronic equipment chassis.

2. The cable entry device of claim 1, wherein the frame includes an upper frame member and a lower frame member that are mated together.

3. The cable entry device of claim 2, wherein the upper and lower frame members are identical.

4. The cable entry device of claim 2, wherein each of the upper frame member and the lower frame member include a central tab extending from a first end and a pair of arms extending from a second end opposite to the first end, wherein the central tab of the upper frame member is inserted between the pair of arms of the lower frame member when the upper frame member and the lower frame member are mated together.

5. The cable entry device of claim 2, wherein the upper and lower frame members each include a registration feature to align the central tab between the pair of arms of the other frame member.

6. The cable entry device of claim 1, wherein the base member is rubber and the frame is plastic or metal.

7. The cable entry device of claim 1, wherein the grommet and slit are one of a plurality of grommets and slits of the base member.

8. The cable entry device of claim 7, wherein the bores in the individual grommets have different internal diameters for receiving cables of different sizes.

9. The cable entry device of claim 7, wherein the bores in individual grommets have the same internal diameter for receiving cables.

10. The cable entry device of claim 1, wherein the frame and the base member include a connector hole to receive a fastener to connect the frame and the base to the electronic equipment chassis.

11. An electronics device for placement in an outside environment, comprising:
a chassis having an opening to receive at least one cable; and
a cable entry device inserted over the aperture, the cable entry device including:
a flexible base member including a grommet with a bore therethrough, and a slit through the grommet, the bore operable to hold the cable; and
a frame mated to the base member, the frame including an aperture aligned with the bore of the grommet and configured to receive the cable, wherein the frame holds the base member to the chassis so the grommet extends through the aperture of the chassis.

12. The electronics device of claim 11, wherein the frame includes an upper frame member and a lower frame member that are mated together.

13. The electronics device of claim 12, wherein the upper and lower frame members each include a central tab extending on one end and a pair of arms extending on an opposite end, wherein the central tab of the upper frame member is inserted between the pair of arms of the lower frame member when the upper and lower frame members are mated together.

14. The electronics device of claim 12, wherein the upper and lower frame members each include a registration feature to align the central tab between the pair of arms of the other frame member.

15. The electronics device of claim 11, wherein the base member is rubber and the frame member is plastic or metal.

16. The electronics device of claim 11, wherein the grommet and slit are one of a plurality of grommets and slits of the base member.

17. The electronics device of claim 16, wherein the bores in individual grommets have different internal diameters for receiving cables of different sizes.

18. The electronics device of claim 16, wherein the bores in individual grommets have the same internal diameter for receiving cables.

19. The electronics device of claim 11, wherein the frame and the base member include a connector hole configured to receive a fastener to connect the frame and the base member to the chassis.

20. A cable entry device for guiding cables through an aperture of an electronic equipment chassis, the cable entry device comprising:
a flexible base member including a first side tab, a second side tab, and a plurality of grommets, each of the plurality of grommets with a bore therethrough, and a slit through each of the plurality of grommets, each of the plurality of grommets configured to hold a cable in the bore;
an upper frame member mated to the first side tab, the upper frame member including a plurality of apertures, each of the plurality of apertures aligned with the bore of one of the plurality of grommets; and
a lower frame member mated to the other second side tab, the lower frame member including a registration feature configured to seat the lower frame member with the upper frame member, wherein the plurality of grommets extend through the electronic equipment chassis when the base member is mated to the upper frame member and the lower frame member.
